(19) United States
(12) Patent Application Publication
(10) Pub. No.: US 2010/0258992 A1
(43) Pub. Date: Oct. 14, 2010

(54) SIMPLIFIED HOLDER TO FACILITATE THE SIGNING OF COLLECTIBLE BASE BALLS AND OTHER SPORTS MEMORABILIA

(76) Inventor: James Schroeder, Teaneck, NJ (US)

Correspondence Address: Patrick P. Zaretski, 63 Third Street, Apt G-6, Clifton, NJ, 07011, US

(21) Appl. No.: 12/734,907

(22) PCT Filed: Sep. 12, 2007
(86) PCT No.: PCT/US2007/019849

§ 371 Date: Jun. 2, 2010

(51) Int. Cl. B25B 1/00

(52) U.S. Cl. 269/3

(57) ABSTRACT

An apparatus, and method of use thereof, to assist in the signing of baseballs or other sports memorabilia articles. Means for attaching or holding a writing implement is provided on the crescent-shaped apparatus, into which a baseball or other sports memorabilia article is removably inserted to allow for more than one use of the apparatus or storage or display of the removed signed baseball or article. In an alternative embodiment, the inner surfaces of the apparatus may also bear rubberized pieces to prevent scuffing or damage of the baseball or sports memorabilia article upon insertion or removal. In a second alternative embodiment, the apparatus may permit differently-sized writing implements to be held. The apparatus may also bear graphical or alphanumeric information for advertising, identification, or other informational uses.

### TECHNICAL FIELD OF THE INVENTION

This invention relates to collectible memorabilia holders, and more particularly to an apparatus, and method of use thereof, for efficiently providing a player on the field of play simultaneously both a collectable sports memorabilia article such as a baseball for his autograph and a writing implement.

### BACKGROUND ART

Since the dawn of professional sports, it has been common among sports fans, athletes, and others to display sports memorabilia, such as autographed baseballs. While it is of course possible to have players autograph baseballs at sports memorabilia stores or other locations, a significant number of autograph signings occur at the baseball field prior to a game's start, when players practice and interact with the fans. Nevertheless, this informal and impromptu signing procedure presents a number of problems to both the signing player and the fan. The most obvious disadvantage a fan faces in such a setting is that many times a player who would be willing to sign a baseball is stymied in his attempt because he does not have a pen. Given the short amount of time a player has between the end of practice and having to depart the field, waiting for a fan to produce a pen is not something a player wishes to do. Also, many times a casual fan does not possess a pen but would still like to have a genuine autographed baseball. It would therefore be desirable for both a fan or baseball collector and a signing player to provide that player with simultaneously with both a baseball to be signed and a pen for the player to use in one convenient package, whether on the field of play or otherwise.

A survey of the prior art reveals devices useful for providing an autographing player simultaneously with a baseball or other collectable sports memorabilia item and a writing implement. Thus, U.S. patent application Ser. No. 10/059,715 filed Jan. 29, 2002 by Picciolini describes a removable ball or puck cover, and method of use thereof, to facilitate the process of obtaining an autograph on the sports item at a sporting event. The ball cover includes a writing instrument attachment for reversibly securing a writing instrument to the cover, thereby allowing a fan to pass both a sports item and attached writing instrument to an athlete for his signature; the cover can also include a lanyard attachment that allows the cover to be worn around a fan's neck. The method for obtaining an autograph on a sports item with this apparatus includes providing a cover, item, and a writing instrument to a signing player, wherein access to a signature location on the item through the cover is provided by an autograph opening in the ball cover, such that the player is obliged to sign the item through the autograph opening. While providing a writing instrument to the signing player, the disadvantage of this invention is that the player is constrained to contain his signature within the enclosed area provided by the opening in the cover, such that players with larger handwriting will be less likely to choose a ball presented with this cover in the limited time they have available prior to a game's start. It is thus preferable to provide the signing player an apparatus with an attached writing instrument which does not unduly regulate the area on a collectable sports item on which the player can place his signature.

By contrast, U.S. Pat. No. 7,445,118 to Schroeder describes an apparatus, and method of use thereof, to assist in the signing and protection of a baseball or other similar sports memorabilia article while on the field of play. The apparatus is to be constructed of plastic, although other durable material may be used. The apparatus consists of a top and bottom end configured as flat discs, or alternatively as a flat top end and an asymmetrically-curved bottom end linked by a central portion. The main body of the apparatus is hollow from the top end through the central portion continuing into the bottom end, providing holes of a circumference large enough to accept a baseball or other similar sports memorabilia article. Means for attaching or holding a writing implement is provided on the main body of the apparatus through a hole formed from a flange extending outwardly from the central portion of the apparatus; alternatively from holes drilled through the top and bottom ends; or from a hole drilled through the top end with a holder affixed to or molded from the material forming the bottom end. The central portion of the main body of the apparatus may be contoured and tapered to facilitate gripping of the apparatus while a player is signing the article, and in an alternative embodiment, the bottom end of the apparatus has concave flanges to further facilitate such gripping. In a second alternative embodiment, the apparatus may be constructed in a two-piece, interlocking design to permit multiple uses. The apparatus may also bear lettering or logos for advertising, identification, or other informational uses on the top or bottom ends or on the central portion. While this apparatus does not limit the area upon which the player may place his signature, this apparatus has the relative disadvantages of a higher production and retail cost, as well as increased weight and bulk for a fan to carry at a sporting event.

### OBJECTS OF THE INVENTION AND INDUSTRIAL APPLICABILITY

Accordingly, it is a general object of the present invention to provide an apparatus, and method of use thereof, to aid in the signing of baseballs and other similar sports memorabilia articles.

It is a specific object of the present invention to provide an apparatus, and method of use thereof, to aid in the signing of baseballs and other similar sports memorabilia articles whereby the player is simultaneously provided with both a baseball or other similar sports memorabilia item to be signed and a pen for the player to use in one convenient, lightweight, and cost-effective package.

### SUMMARY OF THE INVENTION

Consequently, to achieve these and other aims and objectives, the present invention provides for an apparatus, and method of use thereof, to assist in the signing of a baseball or other similar sports memorabilia article. The apparatus is to be constructed of plastic, although other durable material may be used. The apparatus consists of a crescent-shaped main body, in the concave portion of which a Major League Baseball-sized baseball or other similarly-shaped and -sized article of sports memorabilia is to be removably inserted. Thus, the circumference of the main body of the apparatus which accepts the baseball or sports memorabilia article is slightly smaller than the article itself, thereby providing a firm grip on the article to prevent slippage of the apparatus. By allowing the baseball or other sports memorabilia article to be removably inserted, the apparatus may be reused with other baseballs or sports memorabilia articles to be signed, as well as permit the collector to store or view the baseball or piece of memorabilia in more conventional means. Rising upwardly from the apex of the top section of the apparatus, sloping downward towards the rear of the main body, is a section of the apparatus which bears a hole into which a standard-sized writing implement such as a pen may be inserted. This hole opens into a chamber shaped analogously to the shape of a writing implement, extending across the interior of the writing implement holder and terminating in a second, smaller hole on the rear surface of the writing implement holder, which reversibly holds the writing implement. This second hole permits the nib or other end of the writing implement to emerge from the chamber, allowing for tighter grip of the writing implement in the chamber; thus, the chamber size progressively decreases to lock in writing implements of numerous sizes. The writing implement holder section may either be integrated directly into the main body of the apparatus or be a separate unit affixed to the main body through adhesive, heat-bonding, or other means known to those skilled in the art. The main body of the apparatus may also bear alphanumeric or graphical designs for advertising, identification, or other informational uses on the top or bottom ends or on the central portion. In an alternative embodiment of the invention, the interior surface of the area of the apparatus into which the baseball or other sports memorabilia article is inserted may bear rubberized pieces, affixed adhesively or any other fashion, to prevent the apparatus from scuffing or otherwise damaging the baseball or article upon insertion or removal. In a second alternative embodiment of the invention, the upper portion of the writing implement holder section is cut into, thereby forming a slit running centrally along the entire length of the writing implement holder section, from the outer surface of the holder into the writing implement holding chamber. Slitting the section thusly will allow the chamber to expand to permit insertion of an oversized writing implement, such as a marker, into the chamber.

### BRIEF DESCRIPTION OF THE DRAWINGS

FIGS. 1, 2, 3, 4, and 5 show a front, rear, oblique overhead, side, and top view, respectively, of one embodiment of the apparatus with a baseball inserted therein.

FIG. 6 shows a side cross-sectional view of an alternative embodiment of the apparatus with a baseball inserted therein, this embodiment having a rubberized piece affixed on the inner surface of the main body of the apparatus adjoining the baseball or other sports memorabilia article to be inserted.

FIG. 7 shows an oblique overhead view of a second alternative embodiment of the apparatus, this embodiment having a slit cut into the top of the writing implement holder section of the main body of the apparatus.

FIG. 8 shows a rear view of a second alternative embodiment of the apparatus with a baseball inserted therein, showing the slit cut into the top of the writing implement holder section of the main body of the apparatus.

FIG. 9 shows a close-up side cross-sectional view of a second alternative embodiment of the apparatus, showing where the slit is positioned relative to the writing implement holding chamber.

FIG. 10 shows a close-up top view of a second alternative embodiment of the apparatus, showing how the slit allows for expansion and reduction of the size of the writing implement holding chamber.

### DETAILED DESCRIPTION OF THE INVENTION

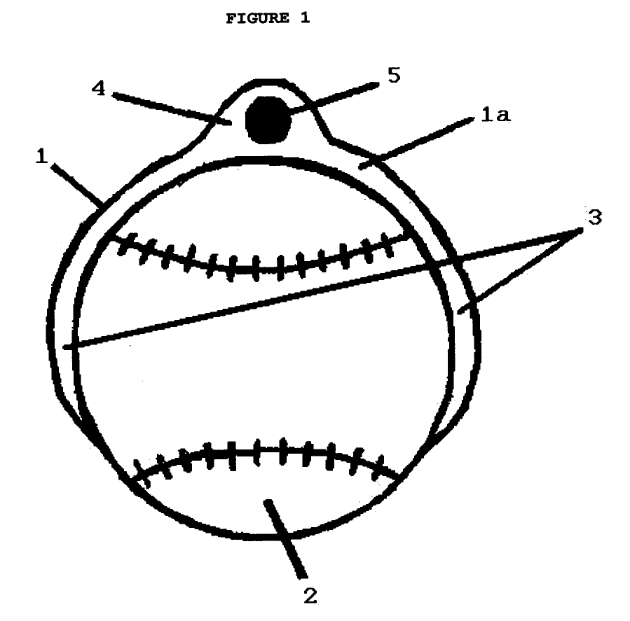

There is depicted in FIG. 1 an apparatus 1 to be used to aid in the signing of a baseball 2 or other article of sports memorabilia, this article available to use either while on the field of play or at other locations. The apparatus 1 is preferably to be constructed from plastic; however, any other type of durable material may be used. The apparatus 1 consists of a crescent-shaped main body, having two downward-projecting arms 3 integrated directly with a central top section 1a. The inner surfaces of the top section 1a and arms 3 form the boundaries of a concave area into which a baseball 2 or other sports memorabilia article is removably inserted. By allowing the baseball 2 or other sports memorabilia article to be removably inserted, the apparatus 1 may be reused with another baseball 2 or sports memorabilia article to be signed, as well as permit the collector to store or view the baseball 2 or piece of memorabilia in more conventional means. While the baseball 2 may be inserted at any point along its circumference, FIG. 1 depicts the baseball with the area known as the “sweet spot” (i.e., the area where the seams of the baseball 2 are closest to each other) both parallel to the top section 1a and perpendicular to the arms 3, as this is the area of the baseball 2 deemed most desirable by autograph collectors to be signed. As a baseball 2 under Major League Baseball rules can have a circumference of no less than 9 inches (″) and no greater than 9.25″, the area formed by the inner surfaces of the top section 1a and arms 3 preferably measures no greater than these dimensions in order to best carry out the objectives of the present invention; however, as it is contemplated that this invention may be used to assist in the signing of other articles of sports memorabilia of a different circumference or size than a Major League Baseball, the size of this area may hence be adjusted accordingly. As is evident from FIG. 1, the apparatus 1 should not wrap around the inserted baseball 2 or other sports memorabilia article more than approximately seventy-five percent (75%) of the circumference of the baseball 2 or other sports memorabilia article. Found atop the top section 1a is a section 4 designed to hold reversibly a writing implement. A centrally-oriented hole 5 provides the writing implement access to the interior of the section 4 for securing the writing implement to the apparatus 1. While it is contemplated that the writing implement holder section 4 is to be integrated directly with the top section 1a of the apparatus 1, the writing implement holder section 4 may be a separate unit formed from the same material made to construct the apparatus 1 and affixed to the top section 1a through the use of adhesive, heat-bonding, or other means known to those skilled in the art.

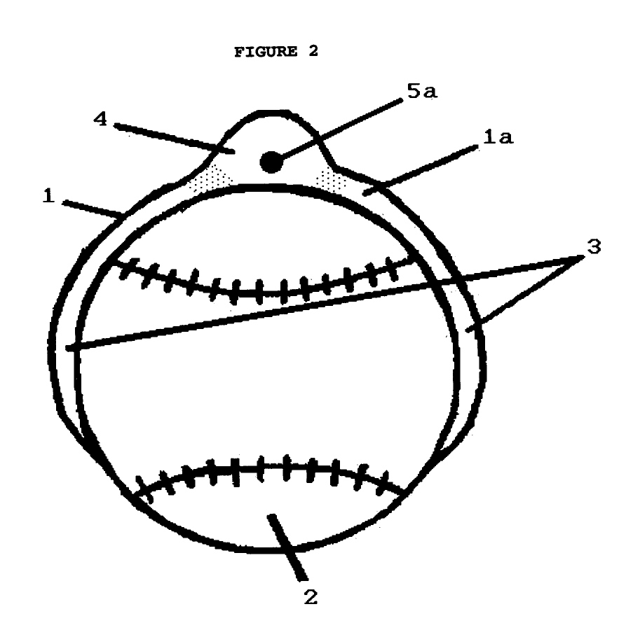

Turning to FIG. 2, it is seen that the writing implement holder section 4 slopes downward from its highest point situated above the apex of the top section 1a of the apparatus 1 to bottom out along the rear of the top section 1a. A hole 5a is centrally drilled into the rear of the writing implement holder section 4 from which the nib or other point of a writing implement inserted into the front hole 5 of the writing implement holder section 4 projects outward.

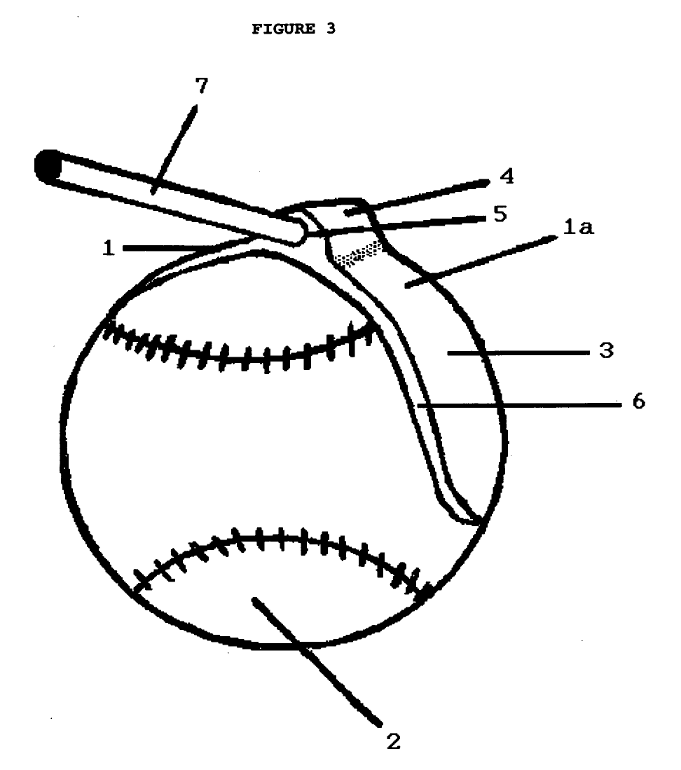

As seen in FIG. 3, the front surface of the top section 1a and downward-projecting arms 3 of the apparatus 1 share a frontward-oriented lip 6 which is flush with the front outer surface of the writing implement holder section 4. This lip 6 will also be formed in the same fashion by the top section 1a and downward-projecting arms 3 with the rear outer surface of the writing implement holder section 4 (undepicted). A pen 7 is inserted into the hole 5 in the writing implement holder section 4 to provide the autographing player with a writing implement on the field of play and is oriented along the slope of the writing implement holder section 4.

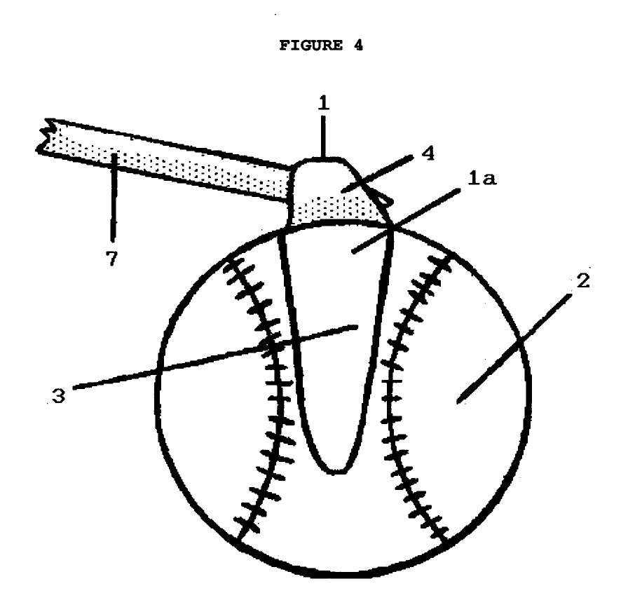

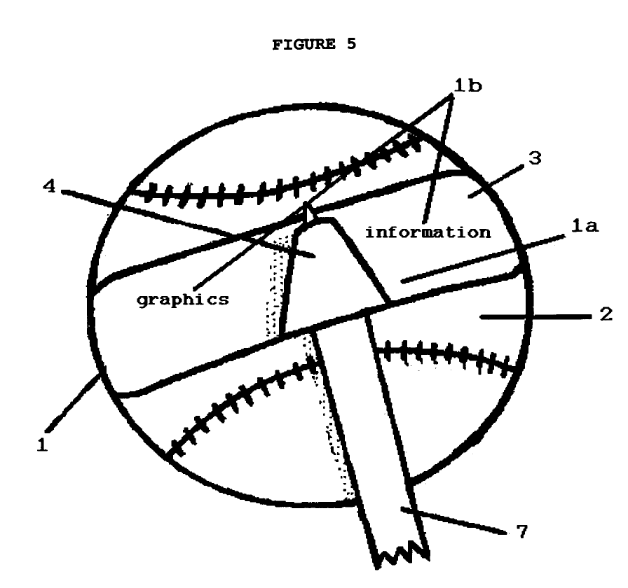

Moving to FIG. 4, the slope of the writing implement holder section 4 downward from its highest point situated above the apex of the top section 1a towards the rear of the top section 1a is evident. Also evident in this figure, as well as in FIG. 5, is the nib of the pen 7 protruding from the rear of the writing implement holder section 4. Such protrusion is necessary for the writing implement to be most securely locked into place in the writing implement holder section 4.

Also seen in FIG. 5, the apparatus 1 may also bear alphanumeric or graphical information 1b like lettering or logos for advertising, identification, or other informational uses on the top portion 1a, arms 3, or writing implement holder section 4 of the apparatus 1. Such alphanumeric or graphical information 1b may be printed, etched, embossed onto the molded plastic of the apparatus 1, or provided for by any other means known to practitioners in the art.

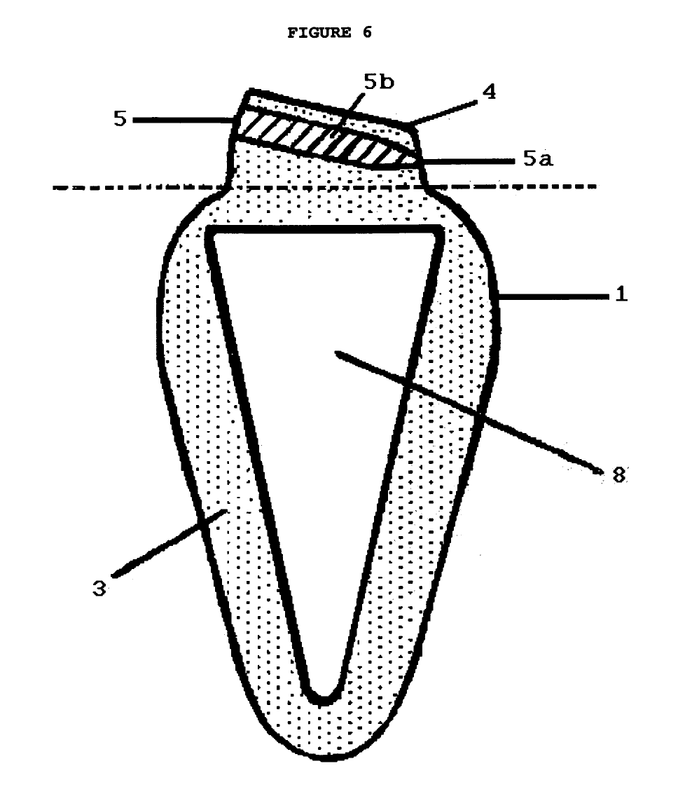

Turning to FIG. 6, the writing implement holder chamber 5b is illustrated in cross-section. The chamber 5b parallels the downward slope of the writing implement holder section 4 and is cylindrically-shaped analogous to the shaft and tapering point of a standard-sized writing implement, such as a pen 7; the axis shown in this illustration shows that the top section 1a and arms are otherwise symmetric below the writing implement holder section 4. The chamber 5b opens to the outer surfaces of the apparatus 1 through the front hole 5, which permits the writing implement to be inserted into the chamber 5b, and through the rear hole 5a, which permits the nib or other point of the writing implement to protrude out of the chamber 5b, thereby most securely locking the writing implement into place in the writing implement holder section 4.

An alternative embodiment of the apparatus 1 is further depicted in FIG. 6. In this embodiment, the inner surface of the area of the apparatus 1 formed by the top section 1a (undepicted in this illustration) and arms 3 into which the baseball 2 or other sports memorabilia article is inserted may bear one or a plurality of rubberized pieces 8 to prevent the apparatus 1 from scuffing or otherwise damaging the baseball 2 or article upon insertion or removal. The rubberized pieces 8 may assume any appropriate shape and are to be affixed to the inner surface of the top section 1a and arms 3 adhesively or in any other fashion known in the art. Furthermore, the rubberized pieces 8 may cover either the entire inner surface of the area of the apparatus 1 formed by the top section 1a (undepicted in this illustration) and arms 3 or merely a portion thereof.

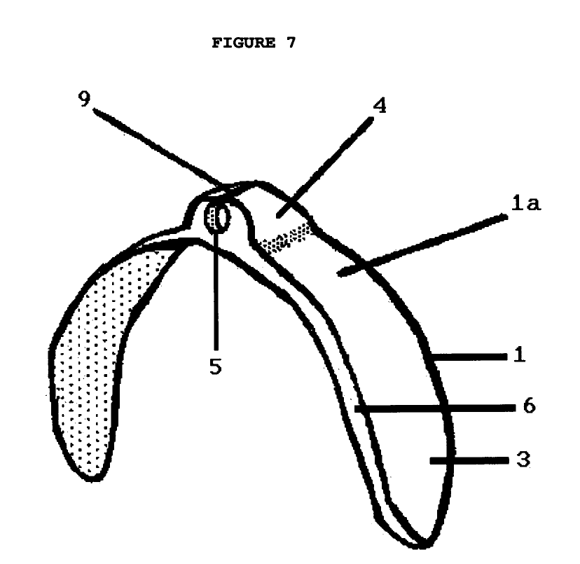

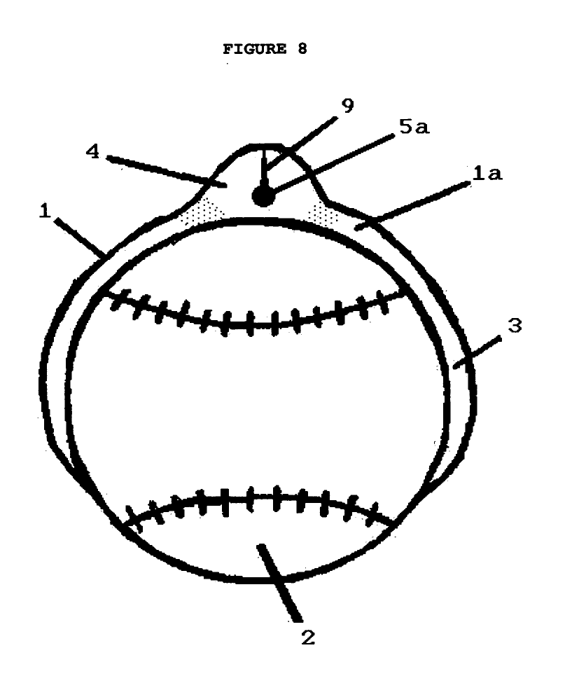

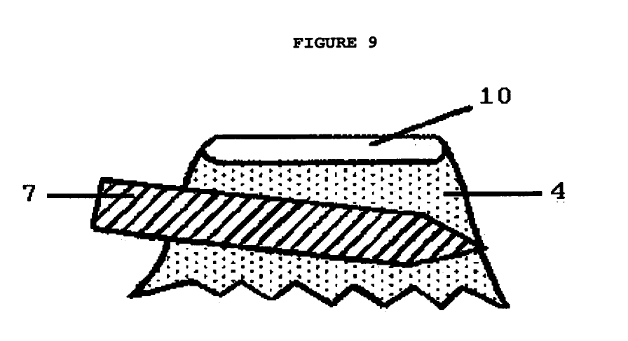

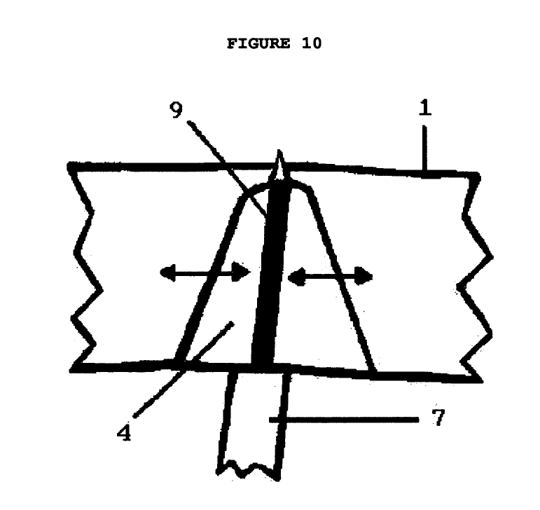

A second alternative embodiment of the apparatus 1 is introduced in FIGS. 7 through 10. This embodiment is identical to the other previously-described embodiments in all other respects save for a slit 9 being cut into the writing implement holder section 4, this slit 9 running centrally along the entire length of the writing implement holder section 4, from the front hole 5 of 4 to the rear hole 5a of the section 4, as seen in FIG. 8, and penetrating into the writing implement holding chamber 5b, as seen in cross-section in FIG. 9. The cut ends 10 of the slit 9 are smooth and run into the top of the writing implement holding chamber 5b, thereby permitting the chamber 5b to expand to permit insertion of an oversized writing implement, such as a marker, into the chamber 5b as is seen in the axis depicted by the arrows in FIG. 10. In this manner, the chamber 5b may also retract along this axis to allow the apparatus 1 to be reused with a smaller-sized writing implement.

The apparatus 1 described herein was designed and manufactured to fit a baseball 2 of Major League Baseball specifications. However, it is contemplated that other types of balls from such different sports as tennis, cricket, hurling, lacrosse, handball, and softball, and other pieces of sports equipment such as hockey pucks are also capable of being signed and fitted into the apparatus 1 in this manner. Furthermore, while an exemplary design has been expressed herein, others practiced in the art may be aware of other designs which may be used. Thus, while the present invention has been described in connection with exemplary embodiments thereof, it will be understood that many modifications in both design and use will be apparent to those of ordinary skill in the art, and this application is intended to cover any adaptations or variations thereof. It is therefore manifestly intended that this invention be limited only by the claims and the equivalents thereof.

1. An apparatus to be used to assist in the signing of a baseball or similar article of sports memorabilia, comprising:
a main body of the apparatus,
this main body having two arms directly integrated into the material forming a central top section,
the arms and top section each having inner and outer surfaces and arranging said main body into a smooth crescent shape,
the inner surfaces of said arms and said top section altogether forming an area within the crescent-shaped main body into which a baseball or similarly-shaped and -sized article of sports memorabilia is removably inserted;
a writing implement, such as but not limited to a pen;
and a section for reversibly holding a writing implement,
this holding section having front, rear, and upper surfaces and being centrally located on the outer surface of the top section of the crescent-shaped main body,
this holding section further having holes drilled in the front and rear surfaces therethrough to form a chamber having an upper surface into which a writing implement is reversibly inserted,
this chamber shaped analogously to the shape of the writing implement,
the nib or point of the writing implement protruding through the hole in the rear surface of said holding section.

2. The apparatus of claim 1, wherein the material forming said apparatus is plastic.

3. The apparatus of claim 1, wherein the material forming the holder section is integrated directly into the material forming the top section of the crescent-shaped main body.

4. The apparatus of claim 1, wherein the holder section is affixed to the outer surface of the top section through means selected from a group consisting of the use of adhesive or thermal bonding.

5. The apparatus of claim 1, wherein the area formed by the inner surfaces of the arms and the top section into which a baseball or similar article of sports memorabilia is removably inserted has a circumference of no less than 9 inches (″) and no greater than 9.25″.

6. The apparatus of claim 1, further comprising a strip or rubberized material affixed to the inner surface of the arms and the top section of the crescent-shaped main body.

7. The apparatus of claim 6, wherein said strip is formed from a plurality of strip segments.

8. The apparatus of claim 6, wherein said strip covers the entire inner surface of the arms and the top section of the crescent-shaped main body.

9. The apparatus of claim 1, wherein a slit is cut into the writing implement holder section and the chamber found therein,
this slit running centrally along the upper surface of the holder section following a line formed by the holes drilled through the front and rear surfaces of said holder section,
this slit further opening into the chamber formed within the holder section and thereby exposing an opening the length of the slit into the upper surface of said chamber.

10. The apparatus of claim 1, further comprising alphanumerical or graphical information provided on the outer surfaces of the arms, the top section, and the holder section of the crescent-shaped main body.

11. The apparatus of claim 10, wherein the graphical information to be provided on the apparatus is so provided from means selected from a group consisting of printing, etching, or embossing onto the molded plastic of the apparatus.

12. A method for obtaining an autograph on a baseball or similar article of sports memorabilia, comprising:
providing the apparatus of claim 1 with a baseball and a writing implement removably inserted therein to a desired autographer;
having the autographer remove the writing implement from the holder section of said apparatus, sign the baseball or similar article of sports memorabilia on a desired location thereupon, and return the writing implement to the holder section;
and retrieving said apparatus from the autographer.

13. The method of claim 12, further comprising:
rotating the baseball or similar article of sports memorabilia within the apparatus of claim 1 relative to the ball cover,
thereby providing a plurality of autographers access to a plurality of potential locations on the baseball or similar article of sports memorabilia and permitting said autographers also to autograph the baseball or similar article of sports memorabilia.

14. The method of claim 12, further comprising:
removing the baseball or similar article of sports memorabilia from the apparatus of claim 1.

15. The method of claim 14, further comprising:
removably inserting one of a plurality of desired different baseballs or similar articles of sports memorabilia into the apparatus of claim 1.

16. The method of claim 12, further comprising:
removing the writing implement from the apparatus of claim 1.

17. The method of claim 16, further comprising:
removably inserting one of a plurality of desired different writing implements into the apparatus of claim 1.
